(19) United States
(12) Patent Application Publication
(10) Pub. No.: US 2024/0024950 A1
(43) Pub. Date: Jan. 25, 2024

(54) CONTINUOUS REACTOR AND ADDITIVE MANUFACTURING OF METALS WITH NANOSTRUCTURED INCLUSIONS

(71) Applicant: Northeastern University, Boston, MA (US)

(72) Inventors: Steven Lustig, Attleboro, MA (US); Randall Erb, Newton, MA (US); Devyesh Rana, Burlington, MA (US)

(21) Appl. No.: 18/225,961

(22) Filed: Jul. 25, 2023

Related U.S. Application Data
(60) Provisional application No. 63/391,825, filed on Jul. 25, 2022.

(51) Int. Cl. B22D 23/00; B33Y 10/00; B33Y 30/00

(52) U.S. Cl. CPC B22D 23/003; B33Y 10/00; B33Y 30/00

(57) ABSTRACT

Provided are methods and flow reactors for the production of covetic materials under continuous flow conditions.

### RELATED APPLICATIONS

This application claims the benefit of priority to U.S. Provisional Patent Application No. 63/391,825, filed Jul. 25, 2022.

### BACKGROUND

There is an urgent need for next generation materials to advance infrastructures and electronics. Key industries with increased demand include renewable energy, electric vehicles, electric power transmission, commercial and residential infrastructure, and strategic defense applications. It is critical to develop new materials that are lighter, stronger, more flexible, more conductive, or more corrosion resistant for longer lifetimes.

Metal composites containing non-metal inclusions could provide improvements in strength, resistance to cracking, and lighter weight as compared to metals and metal alloys. These materials also may have higher conductivity compared to composites having a non-metal base material. However, the fabrication of such metal-based composites is problematic, as is casting such materials into useful articles. In the past, graphitic carbon nanoribbons have been produced using electrochemical reaction of carbon feedstocks mixed in large batch crucibles of liquid metal that are immobilized within stationary induction furnaces. Despite stirring the reaction mixture, the graphitic carbon is not produced uniformly within the metal, there are voids, and the overall yield is low. Furthermore, only casting could be used to obtain a product in a desired final form, limiting the shapes and topological complexity of the final forms.

Covetics are a novel class of metal-carbon nanocomposites traditionally fabricated in an induction furnace with high power electrical current in the liquid metal-carbon mixture. While exact structures are not known, it is hypothesized that covetics are nanocomposite materials with single, double, and triple carbon-metal bonds such that the metal and carbon species do not separate into different phases upon remelting and solidification. Covetic materials have improved properties over the base metal including lower or higher density, improved electrical conductivity, improved mechanical moduli, and improved strength. However, covetics still face several challenges that prevent commercial application and large-scale production. There are neither standardized protocols, nor processes for synthesizing uniform and reproducible covetics. This results in conflicting experimental evidence of carbide formation during covetic synthesis. Difficulty in processing covetics leads to inhomogeneous distribution of carbon; which leads to low yields and undesirable properties. The governing chemical mechanisms, thermodynamics, and kinetics are unknown. Improved methods for preparation of covetic materials are needed.

### SUMMARY OF THE INVENTION

In certain aspects, the invention provides methods for producing a covetic material, the method comprising:
(a) combining under continuous flow conditions a liquid metal material and one or more non-metallic precursor materials, thereby forming a liquid covetic precursor material;
(b) continuously passing an electric current through the liquid covetic precursor material, thereby forming a liquid covetic material comprising metal and a plurality of non-metallic structures; and
(c) continuously depositing the liquid covetic material onto a substrate.

In certain aspects, the invention provides a covetic material produced by the methods of the invention.

In certain aspects, the invention provides a covetic material with improved uniformity produced by the methods of the invention.

In certain aspects, the invention provides flow a reactor for producing a covetic material, comprising:
a first zone, comprising a liquid metal material inlet, a non-metallic precursor materials inlet, and a covetic precursor material outlet; and
a second zone, comprising a covetic precursor material inlet and a covetic material outlet; wherein the covetic precursor material inlet is coupled to the covetic precursor material outlet from the first zone.

### BRIEF DESCRIPTION OF THE DRAWINGS

FIG. 1 shows a schematic of a first configuration of a flow reactor.

FIG. 2 shows a schematic of a second configuration of a flow reactor.

FIG. 3 shows a schematic of a third configuration of a flow reactor.

FIG. 4 shows a schematic of a fourth configuration of a flow reactor.

FIG. 5 shows a schematic of a fifth configuration of a flow reactor.

### DETAILED DESCRIPTION OF THE INVENTION

This invention is based on the surprising discovery that covetic materials can be produced with improved properties with uniformity under continuous flow conditions as compared to traditional manufacturing methods. The continuous process permits additive manufacturing of final forms with desired shape and topology while having the desired properties of the nanocomposite material with uniformity. The nanocomposite material has improved properties as compared to metallic materials or composites with metal-only inclusions and as compared to covetic materials manufactured in traditional, non-continuous ways.

The present invention provides a method that utilizes a continuous reactor that enables melting of the metal simultaneously with applying high electric current needed for the electrochemical polymerization of non-metal nano structures with flow residence time, enabling significant conversion of the feedstock. In some embodiments, the process may be miniaturized to enable additive manufacturing of the composite into desired shapes and forms. The process also provides uniformity and stability of flow and composition to enable the measurement of growth kinetics of the nanostructure.

Known methods of making covetic materials are described in Rana et al., Nanoscale Adv. 2023, 5, 11-26, which is incorporated herein by reference in its entirety.

### Methods of Covetic Material Production

In certain aspects, provided herein are methods for producing a covetic material, the method comprising:
(a) combining under continuous flow conditions a liquid metal material and one or more non-metallic precursor materials, thereby forming a liquid covetic precursor material;
(b) continuously passing an electric current through the liquid covetic precursor material, thereby forming a liquid covetic material comprising metal and a plurality of non-metallic structures; and
(c) continuously depositing the liquid covetic material onto a substrate.

In certain embodiments, the method further comprises liquifying a solid metal material to form the liquid metal material. In further embodiments, the solid metal material and the non-metallic materials are separately spooled. In further embodiments, the solid metal material and the non-metallic materials are separately spooled. In yet further embodiments, the solid metal material is in the form of a wire, thread, tube or rod. In still further embodiments, the solid metal material is coated by the one or more non-metallic precursor materials. In still further embodiments, the solid metal material coats the one or more non-metallic precursor materials.

In certain embodiments, the one or more non-metallic precursor materials is a solid. In further embodiments, the one or more non-metallic precursor materials is a liquid. In yet further embodiments, the solid metal material is not in contact with the one or more non-metallic precursor materials. In still further embodiment, the non-metal material can be mostly carbon, such as amorphous carbon, turbostratic carbon, graphitic carbon, or an organic material, such as polyethylene, polystyrene, polyester, or natural polymer, or other synthetic polymer, or a blend of polymers and copolymers.

In certain embodiments the method further comprises further comprising heating the solid metal material to form the liquid metal material. In further embodiments, the heating is electrical resistance heating. The heating can be controlled by a temperature-sensor associated with the wall so that the heating wall maintains a desired temperature within the reacting liquid covetic precursor material. In yet further embodiments, the solid metal material is selected from the group consisting of aluminum, copper, silver, gold, iron, magnesium, titanium, zirconium, nickel, zinc, palladium, platinum, molybdenum, tin, metallic alloys thereof, and metallic composites. In further embodiments, the solid metal material is selected from the group consisting of aluminum, copper, silver, gold, iron, and metallic alloys thereof. In still further embodiments, the one or more non-metallic precursor materials is carbon or a polymer. In further embodiments, the one or more non-metallic precursor materials is selected from the group consisting of carbon, silicon, sulfur, phosphorous, boron, germanium, tellurium, selenium, and non-metallic mixtures thereof. In yet further embodiments, the one or more non-metallic precursor material is carbon. In still further embodiments, the method further comprises blanketing the liquid metal material and one or more non-metallic precursor materials with an inert gas, such as argon or nitrogen. In further embodiments, the liquid covetic precursor material is not stirred.

In certain embodiments, the electric current passes through the liquid covetic precursor material between an anode and a cathode. In further embodiments, the anode and cathode comprise carbon, a metal, or other electrically conducting or semiconducting material. In yet further embodiments, the electrical current is a sinusoidal current. In some embodiments, the electrical current is a time-varying current such as a square wave current. In still further embodiments, the electrical current is a constant current. In still further embodiments, the electric current comprises a combination of a constant current and a time-varying current.

Numerous reactor configurations may be employed in the methods of the invention.

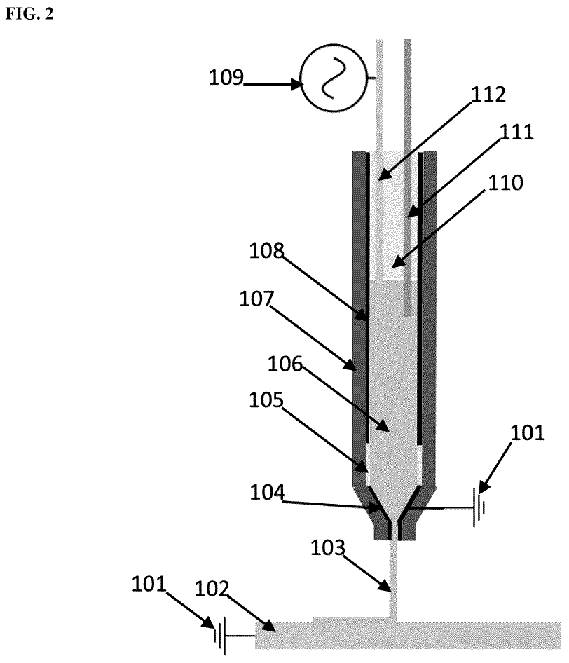

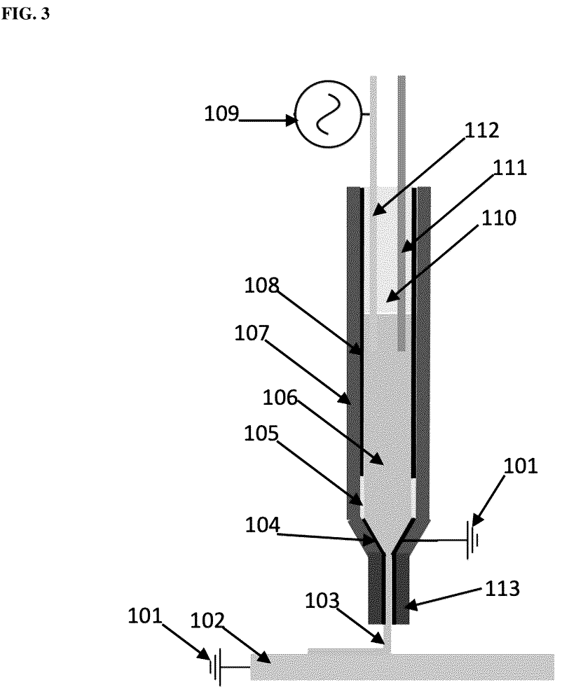

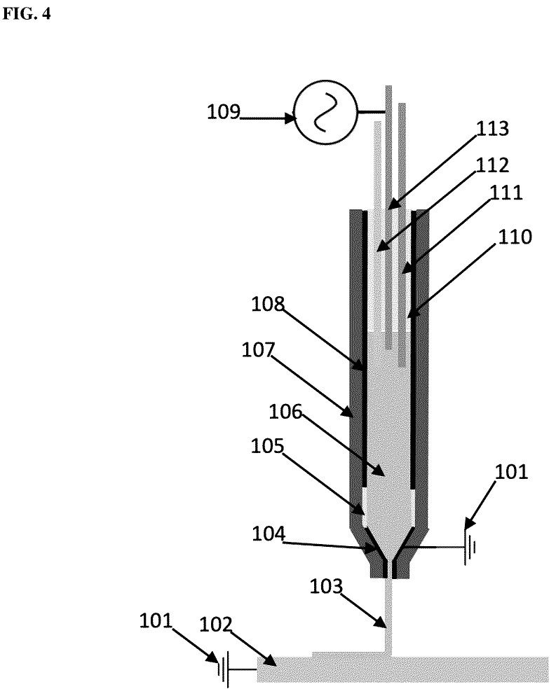

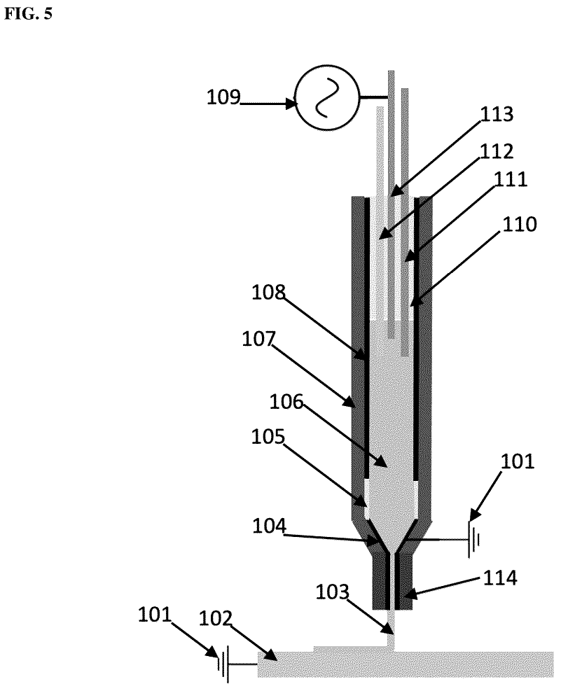

In certain embodiments, the reactor bottom and/or deposition surface are electrically configured as the anode; and the reactor top is electrically configured as the cathode. Since the metal feed is electrically conductive, the cathode supply may be connected to either the metal feed, see, e.g., FIGS. 2 and 3, or a conducting electrode body, see, e.g. FIGS. 4 and 5. In alternative embodiments, the reactor bottom and/or deposition surface are electrically configured as the cathode; the reactor top is electrically configured as the anode. Since the metal feed is electrically conductive, the anode supply can be connected to either the metal feed, e.g. FIGS. 2 and 3, or a conducting electrode body, e.g. FIGS. 4 and 5.

A mechanism for fabrication of covetic materials is described in in Rana et al., Nanoscale Adv. 2023, 5, 11-26, which is incorporated herein by reference in its entirety. Without being bound to theory, in certain embodiments, the liquid covetic material is formed by the following mechanism: ionization of carbon fragments under the electric current; polymerization of carbon ions to form, e.g., chains, ribbons, and graphene; and bond formation between carbon ions and metal ions, which acts as nucleation sites for carbon nanoribbon growth and non-metallic structure formation. In further embodiments, the bond formation between carbon ions and metal ions can be single, double, or triple bonds. In yet further embodiments, the carbon-metal bonds have covalent character. In still further embodiments, the covetic material does not separate into metal and non-metal components upon re-melting and solidification.

In certain embodiments, the non-metallic structures are microstructures. As used herein, a microstructure is a structure having particulate or other form and having at least one dimension less than about 1000 μm or less than about 100 μm, or having all dimensions within that range. In further embodiments, the non-metallic structures are nanostructures. As used herein, a nanostructure is a structure having particulate or other form and having at least one dimension less than about 1000 nm or less than about 100 nm, or having all dimensions within that range. In yet further embodiments, the non-metallic structures comprise graphene, graphitic ribbons or plates, graphides, graphites, a conductive polymer, a nonconductive polymer, or a combination thereof.

In certain embodiments, continuously depositing the liquid covetic material onto a substrate occurs under atmospheric pressure. In further embodiments, continuously depositing the liquid covetic material onto a substrate occurs under pressure greater than atmospheric pressure. For example, if the liquid covetic material is viscous, force can be applied to the feed or feeds to push the material through the extruding nozzle. In yet further embodiments, the method further comprises allowing the liquid covetic material to cool. In still further embodiments, the covetic material is allowed to cool within an enclosing environment such as a gas, liquid, plasma, or combination of fluids.

In certain embodiments, the covetic material is a single-phase material. In further embodiments, the non-metallic structures are homogeneously distributed throughout the covetic material. In yet further embodiments, the covetic material is a three-dimensional material. In still further embodiments, the covetic material is substantially free of carbides. In certain embodiments, the covetic material is substantially free of oxides. In further embodiments, the method allows for additive manufacturing, e.g., 3D printing of covetic materials. The covetic materials can be produced with desired shapes, sizes, and properties directly from the flow reactor. In yet further embodiments, the covetic materials made by the methods of the invention are not stored in a reservoir or holding tank as disclosed in US 2020/0071796 A1. Because the covetic materials made by the methods of the invention may be used to produce articles by additive manufacturing, the method does not require the use of molds to achieve desired shapes.

In certain aspects, the invention provides a covetic material produced by the methods of the invention.

### Flow Reactors for Production of Covetic Materials

In certain aspects, provided herein are flow reactors for producing a covetic material, comprising:
a first zone, comprising a liquid metal material inlet, a non-metallic precursor materials inlet, and a covetic precursor material outlet; and
a second zone, comprising a covetic precursor material inlet and a covetic material outlet; wherein the covetic precursor material inlet is coupled to (e.g., in fluid communication with) the covetic precursor material outlet from the first zone.

In certain embodiments, the flow reactor further comprises a top zone; wherein the top zone comprises a heating element, a feeder, a solid metal inlet, and a liquid metal outlet; and the liquid metal outlet is coupled to (e.g., in fluid communication with) the liquid metal inlet from the first zone. In certain embodiments, the zones are arranged vertically. In further embodiments, the flow reactor zones are horizontal.

In further embodiments, the flow reactor further comprises a mechanically-driven spool coupled to the feeder. In further embodiments, the mechanically driven spool can be covered by an electrically-insulating housing to prevent electrical shock. In yet further embodiments, a high-temperature-resilient, electrically-insulating feed guide may be a ceramic material that fills the space between the reactor walls and feed material to prevent the reacting materials from contacting air. The feed material is optionally blanketed with an inert gas, such as argon, nitrogen.

In certain embodiments, the flow reactor further comprises an anode and a cathode. In further embodiments, the flow reactor further comprises a heating wall along the first, and second zones; wherein the heating wall providing heat to the apparatus. In yet further embodiments, the flow reactor further comprises a reactor wall, wherein the reactor wall is electrically conducting or electrically insulating. In still further embodiments, a cross-section of the flow reactor is circular, elliptical, rectangular, or polygonal.

In certain embodiments, the flow reactor further comprises a nozzle coupled to the covetic material outlet of the second zone. In further embodiments, the flow reactor further comprises a substrate underneath the nozzle. In yet further embodiments, the substrate can be conductive. In still further embodiment, the substrate can cool the liquid covetic material. In certain embodiments, the substrate is the anode and the first zone is the cathode. In further embodiments, the anode supply can be connected to either the metal feed, see, e.g., FIGS. 2 and 3, or a conducting electrode body, see, e.g., FIGS. 4 and 5. In further embodiments, the substrate is the cathode and the first zone is the anode. In yet further embodiments, the cathode supply can be connected to either the metal feed, see, e.g., FIGS. 2 and 3, or a conducting electrode body, see, e.g., FIGS. 4 and 5.

In further embodiments, a high-temperature-resilient, electrically-insulating reactor wall separates the anode and cathode zones of the flow reactor. The length of this separation can be increased to provide more reaction time, or decreased to provide less reaction time. In yet further embodiments, the high temperature-resilient reactor wall can be either electrically conducting or electrically insulating. In still further embodiments, the conducting electrode in FIGS. 4 and 5 can be a carbon electrode, a metal electrode, or other material that is electrically conducting or electrically semiconducting.

In certain embodiments, the cooler in FIGS. 3 and 5 is a process zone for the covetic extrudate that reduces the temperature of the reacting covetic. The covetic temperature is reduced so that the material either remains fluid or becomes solid.

In certain embodiments, the flow reactor and substrate can be moved relative to each other so that the covetic material is deposited on the substrate to any desired two- or three-dimensional pattern.

In certain embodiments, the flow reactor and substrate operate under a gravitational field. In still further embodiments, the flow reactor and substrate operate in the absence of any appreciable gravitational field.

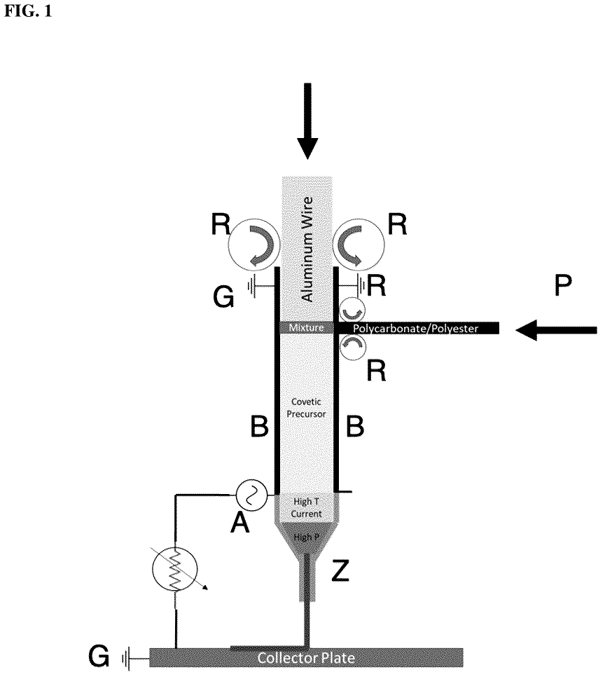

In certain embodiments, the flow reactor includes an entrance for continuous, steady and rate-adjustable feed of a metal or metal wire into the reactor top. For example, the metal or metal wire can include aluminum or aluminum wire, or can include other metals or metal alloys. The metal material is heated to a temperature sufficient to melt the metal into a liquid state by conduction heaters around the body of the apparatus as well as the resistive heating that occurs with the passage of high electrical current. Into the liquid metal is introduced a feedstock reactant that produces a non-metallic structure, such as a microstructure or nanostructure, within the liquid metal. For example, the inclusion feedstock reactant can include an organic polymer, a plastic, a polycarbonate, a polyester, or a combination thereof that reacts in the presence of the elevated temperature and electric current to produce non-metallic inclusions, such as graphene, graphitic ribbons, and/or graphitic plates. The non-metallic inclusions can form due to the reactions at the cathode and anode surfaces within the apparatus body. The apparatus body preferably provides stable, laminar flow with sufficient residence time for the reactants to form the nanostructure from the feedstock material to a desired conversion. In further embodiments, the entire flow reactor is scalable. In an example, the flow reactor can be miniaturized and configured for additive manufacturing or 3D printing of a manufactured component (FIG. 1). For example, the methods and flow reactors provided herein enable production of complicated components for electronic devices, thermoelectric materials, high-performance mechanical structures, low density, corrosion resistance, military, aircraft, marine, battery, solar power generation, and automotive components.

The methods and flow reactors provided herein enables production of components, for example, including corrosion resistance, high damping capacity, improved resistance to fracture, improved lubrication, wear resistance, or a combination thereof.

Embodiments of the methods and flow reactors provided herein can provide any one or all of the following exemplary novel features:
1. The process for making the nanostructured inclusion (nanostructures, e.g. graphene sheets and ribbons) can be continuous within a melted metal composition.
2. Metallic nanocomposites can be extruded to enable additive manufacturing and 3D printing.
3. The process enables additive manufacturing in conjunction with an electrochemical reaction.
4. The process provides product uniformity and stability of flow and reaction.

Embodiments of the disclosed methods and flow reactors provide any or all of the following advantages:
1. The process accesses metal composites with improved properties relative to the individual components.
2. The process accesses metal composites with improved uniformity in composition than the previous batch processes.
3. The metal composites can be printed into desired shapes and forms using additive manufacturing.
4. The continuous process eliminates waste and unusable material lost by stirring.
5. The continuous additive manufacturing process eliminates the need for casting molds.
6. The uniformity and stability of flow and reaction enables the measurement of growth kinetics of the nano structure.
7. The process product does not separate into compositional phases upon remelting and solidification.

The methods described herein are highly tunable, providing access to covetic materials with a desired set of properties. The methods of the invention and covetic materials produced by them include production of composite material in the forms of wire, cables, fibers and other such linear forms that have the properties of the composite material; production of composite material in the form of connectors and articulated parts that have the properties of the composite material; production of composite material in a desired shape that have the properties of the composite material; and production of material that facilitates the measurement of chemical kinetics in states that vary temperature, composition, and electrochemical potential.

Compared to components or products produced from a base metal or alloy, the methods and flow reactors provided herein can provide components or products including nanostructured inclusions. The nano-structured composites can have higher strength, higher conductivity, higher density, or lower density than the pure metal component. The materials produced can be lightweight materials that are electrically conductive in general.

The process enables metal composites that improve the properties and combinations of properties relative to the individual components, such as higher conductivity with lower weight. Thus, the materials can provide more weight-efficient electrical components for vehicles. The continuous process can eliminate waste and unusable material lost by stirring, and also can enhance capital productivity from avoiding inter-batch down time. The continuous additive manufacturing process enables parts printed into arbitrary shapes and eliminates the need for casting molds. The technology provides financial advantages over what is currently done.

### Definitions

Listed below are definitions of various terms used herein. These definitions apply to the terms as they are used throughout this specification and claims, unless otherwise limited in specific instances, either individually or as part of a larger group.

Unless defined otherwise, all technical and scientific terms used herein generally have the same meaning as commonly understood by one of ordinary skill in the art to which this invention belongs. Generally, the nomenclature used herein and the laboratory procedures in chemistry and engineering are those well-known and commonly employed in the art.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used herein, the term “about” will be understood by persons of ordinary skill in the art and will vary to some extent on the context in which it is used. As used herein when referring to a measurable value such as an amount, a temporal duration, and the like, the term “about” is meant to encompass variations of ±5%, from the specified value, as such variations are appropriate to perform the disclosed methods.

As used in the specification and in the claims, the term “comprising” may include the embodiments “consisting of” and “consisting essentially of.” The terms “comprise(s),” “include(s),” “having,” “has,” “may,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated compounds, which allows the presence of only the named compounds, along with any carriers, e.g., pharmaceutically acceptable carriers, and excludes other compounds.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

As used herein, a “covetic material” is a metal or metal alloy composite material that contains non-metallic inclusions, such as carbon-containing or other non-metallic materials, which may be in the form of microstructures and/or nanostructures that do not separate into compositional phases upon remelting and solidification. As used herein, a “meta material” refers to a material consisting substantially or essentially of any known metal or metal alloy, or combination thereof.

As used herein, the term “single phase” refers to phases discernable by the naked eye or using only slight magnification (e.g., at most about 100 times magnification). Therefore, a material appearing as a single phase to the naked eye, but showing two distinct phases when viewed on the nano-scale should not be construed as having two phases.

As used herein, the term “carbon” refers to amorphous carbon, turbostratic carbon, graphitic carbon, or mixture therefrom.

As used herein, the term “polymer” may refer to a natural or synthetic polymer (e.g., polyethylene, polystyrene, polyester).

### EXAMPLES

In order that the invention described herein may be more fully understood, the following examples are set forth. The examples described in this application are offered to illustrate the compositions and methods provided herein and are not to be construed in any way as limiting their scope.

### Example 1: Flow Reactor Configuration 1 (FIG. 1)

FIG. 1 depicts a first configuration of a flow reactor. The flow reactor comprises the following elements:
R rolling feeder
G electrical ground
P feed polymer wire, filament, or other shaped material
B flow reactor body
A an electrode connection
Z a constricting flow exit zone

### Example 2: Flow Reactor Configuration 2 (FIG. 2)

FIG. 2 depicts a second configuration of a flow reactor. Configuration 2 comprises the cathode (mode I)/anode (mode II) coupled to the solid metal material. The flow reactor comprises the following elements:
101 electrochemical anode mode I (or cathode mode II)
102 deposition substrate (electrically conducting optional, cooled optional)
103 covetic extrudate
104 high temperature-resilient, electrically-conducting reactor nozzle wall
105 high-temperature-resilient, electrically-insulating reactor wall
106 reacting covetic
107 heating wall
108 high temperature-resilient reactor wall
109 electrochemical cathode mode I (or anode mode II)
110 high-temperature-resilient, electrically-insulating feed guide
111 organic feed from spool
112 metal feed from spool.

### Example 3: Flow Reactor Configuration 3 (FIG. 3)

FIG. 3 depicts a third configuration of a flow reactor. Configuration 3 comprises a cooler coupled to the nozzle, and the cathode (mode I)/anode (mode II) coupled to the solid metal material. The flow reactor comprises the following elements:
101 electrochemical anode mode I (or cathode mode II)
102 deposition substrate (electrically conducting optional)
103 covetic extrudate
104 high temperature-resilient, electrically-conducting reactor nozzle wall
105 high-temperature-resilient, electrically-insulating reactor wall
106 reacting covetic
107 heating wall
108 high temperature-resilient reactor wall
109 electrochemical cathode mode I (or anode mode II)
110 high-temperature-resilient, electrically-insulating feed guide
111 organic feed from spool
112 metal feed from spool
113 cooler

### Example 4: Flow Reactor Configuration 4 (FIG. 4)

FIG. 4 depicts a fourth configuration of a flow reactor. Configuration 4 comprises the cathode (mode I)/anode (mode II) coupled to a conducting electrode body. The flow reactor comprises the following elements:
101 electrochemical anode mode I (or cathode mode II)
102 deposition substrate (electrically conducting optional)
103 covetic extrudate
104 high temperature-resilient, electrically-conducting reactor nozzle wall
105 high-temperature-resilient, electrically-insulating reactor wall
106 reacting covetic
107 heating wall
108 high temperature-resilient reactor wall
109 electrochemical cathode mode I (or anode mode II)
110 high-temperature-resilient, electrically-insulating feed guide
111 organic feed from spool
112 metal feed from spool
113 conducting electrode

### Example 5: Flow Reactor Configuration 5 (FIG. 5)

FIG. 5 depicts a fifth configuration of a flow reactor. Configuration 5 comprises a cooler coupled to the nozzle, and the cathode (mode I)/anode (mode II) coupled to a conducting electrode body. The flow reactor comprises the following elements:
101 electrochemical anode mode I (or cathode mode II)
102 deposition substrate (electrically conducting optional)
103 covetic extrudate
104 high temperature-resilient, electrically-conducting reactor nozzle wall
105 high-temperature-resilient, electrically-insulating reactor wall
106 reacting covetic
107 heating wall
108 high temperature-resilient reactor wall
109 electrochemical cathode mode I (or anode mode II)
110 high-temperature-resilient, electrically-insulating feed guide
111 organic feed from spool
112 metal feed from spool
113 conducting electrode
114 cooler

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method for producing a covetic material, the method comprising:
(a) combining under continuous flow conditions a liquid metal material and one or more non-metallic precursor materials, thereby forming a liquid covetic precursor material;
(b) continuously passing an electric current through the liquid covetic precursor material, thereby forming a liquid covetic material comprising metal and a plurality of non-metallic structures; and
(c) continuously depositing the liquid covetic material onto a substrate.

2. The method of claim 1, further comprising liquifying a solid metal material, thereby forming the liquid metal material.

3. (canceled)

4. The method of claim 2, wherein the solid metal material is coated by the one or more non-metallic precursor materials, or the one or more non-metallic precursor materials is coated by the solid-metal material.

5. (canceled)

6. The method of claim 1, wherein the one or more non-metallic precursor materials is a solid or a liquid.

7. (canceled)

8. The method of claim 2, wherein the solid metal material is not in contact with the one or more non-metallic precursor materials.

9-10. (canceled)

11. The method of claim 2, wherein the solid metal material is selected from the group consisting of aluminum, copper, silver, gold, iron, magnesium, titanium, zirconium, nickel, zinc, palladium, platinum, molybdenum, tin, metallic alloys thereof, and metallic composites.

12. (canceled)

13. The method of claim 1, wherein the one or more non-metallic precursor materials is carbon or a polymer.

14. The method of claim 1, wherein the one or more non-metallic precursor materials is selected from the group consisting of carbon, silicon, sulfur, phosphorous, boron, germanium, tellurium, selenium, and mixtures thereof.

15. (canceled)

16. The method of claim 1, further comprising blanketing the liquid metal material and one or more non-metallic precursor materials with an inert gas.

17. (canceled)

18. The method of claim 1, wherein the electric current passes through the liquid covetic precursor material between an anode and a cathode, optionally wherein the anode and the cathode independently comprise carbon, a metal, or another electrically conducting or semiconducting material.

19. (canceled)

20. The method of claim 1, wherein the electrical current is a sinusoidal current.

21. The method of claim 1, wherein the electrical current is a time-varying current, a constant current, or combination thereof.

22-23. (canceled)

24. The method of claim 1, wherein the non-metallic structures are microstructures and/or nano structures.

25. (canceled)

26. The method of claim 1, wherein the non-metallic structures comprise graphene, graphitic ribbons or plates, graphides, graphites a conductive polymer, a nonconductive polymer, or a combination thereof.

27. The method of claim 1, wherein continuously depositing the liquid covetic material onto a substrate occurs under atmospheric pressure or under pressure greater than atmospheric pressure.

28-30. (canceled)

31. The method of claim 1, wherein the covetic material is a single-phase material.

32. The method of claim 1, wherein the covetic material does not separate into compositional phases upon remelting and solidification.

33. The method of claim 1, wherein the non-metallic structures are homogeneously distributed throughout the covetic material.

34. The method of claim 1, wherein the covetic material is a three-dimensional material.

35. The method of claim 1, wherein the covetic material is substantially free of carbides, oxides, or both carbides and oxides.

36. (canceled)

37. A covetic material produced by the method of claim 1.

38. A flow reactor for producing a covetic material, comprising:
a first zone, comprising a liquid metal material inlet, a non-metallic precursor materials inlet, and a covetic precursor material outlet; and
a second zone, comprising a covetic precursor material inlet and a covetic material outlet; wherein the covetic precursor material inlet is coupled to the covetic precursor material outlet from the first zone.

39-52. (canceled)
